(19) United States
(12) Patent Application Publication
(10) Pub. No.: US 2017/0245633 A1
(43) Pub. Date: Aug. 31, 2017

(54) LAUNDRY SHELF

(71) Applicant: Randy Heybl, Santa Maria, CA (US)

(72) Inventor: Randy Heybl, Santa Maria, CA (US)

(21) Appl. No.: 15/400,836

(22) Filed: Jan. 6, 2017

Related U.S. Application Data
(60) Provisional application No. 62/275,725, filed on Jan. 6, 2016.

(51) Int. Cl. A47B 5/02; D06F 39/12; A47B 96/02; F16B 11/00; F16B 1/00

(52) U.S. Cl. CPC A47B 5/02; F16B 11/006; F16B 1/00; A47B 96/021; D06F 39/12; F16B 2001/0035

(57) ABSTRACT

Laundry shelves and laundry shelving systems are disclosed. The laundry system comprises a laundry machine having front and back portions and a wall adjacent the laundry machine's back portion, with a space between the back portion and wall. A laundry machine shelf is mounted to the back portion and spans the space between said back portion and said wall. The shelf comprises a planar body having a bottom surface, a top surface and a perimeter wall. One or more legs are included on the bottom surface of the body. A first adhesive is included on the front bottom surface of the body for adhering the body to a horizontal surface of the back portion. A magnet or second adhesive is included to hold each of the legs to a vertical surface of said back portion. Rubber pads or spacers can be included on a back surface of the body with the back surface being against the adjacent wall.

The application claims the benefit of U.S. Provisional Patent Application Serial No. 62/275,725.

### BACKGROUND OF THE INVENTION

Field of the Invention

The present invention relates to shelving and in particular a shelf adapted to mounting to a laundry washer or dryer.

Description of the Related Art

Clothes washers and dryers are a standard appliance in most homes. They provide a convenient way to wash and dry dirty clothing. These appliances are usually found in a laundry room where the necessary electrical and plumbing supplies are located to ensure efficient operation. Natural gas, water and electricity are supplied at higher volume than most other appliances in the home. Specialized electrical, water and natural gas devices are housed behind the washer and dryer. There are also specialized hoses and ducting to facilitate the expulsion of hot air from the dryer and dirty water from the washer.

These specialized hoses, gas lines and cabling take up room behind the washer and dryer. As a result, every washer and dryer requires a 6″ to 7″ space behind them to accommodate for the hoses, ducting etc.

Most users of home washers or dryers have had the unfortunate experience of taking an armful of laundry out of the washer or dryer and having items fall into the space behind the washer or dryer. It can be very difficult and frustrating to try and retrieve these items (socks, underwear, shirts etc.) from behind the washer or dryer. During use, many washers or dryers can become littered with lost clothing items some of which may never be recovered.

There are is also a need for shelf space in many laundry rooms to hold items such as washing detergent or softener containers, and it is helpful to have these items in a location for easy access while washing and drying clothes. Many laundry rooms have a shortage of convenient shelf space and often these items are stored in an inconvenient location or clutter the areas around the washer and dryer, such as the floor.

### SUMMARY OF THE INVENTION

The present invention is generally directed to shelf or laundry shelving system that can be easily mounted to a laundry washer or dryer (“laundry machine”) to provide a rugged and reliable shelf that blocks the space between the back of the laundry machine.

One embodiment of a laundry shelf according to the present invention comprises a planar body having a bottom surface, a top surface and a perimeter wall. One or more legs are on the bottom surface of the body and a first adhesive on the front bottom surface of the body for adhering the body to a first surface of a laundry machine. A magnet or second adhesive is included to hold each of the legs to a second surface of a laundry machine.

One embodiment of a laundry shelving system according to the present invention comprises a laundry machine having front and back portions and a wall adjacent the laundry machine's back portion, with a space between the back portion and wall. A laundry machine shelf is mounted to the back portion and spans the space between said back portion and said wall. The shelf comprises a planar body having a bottom surface, a top surface and a perimeter wall. One or more legs are included on the bottom surface of the body. A first adhesive is included on the front bottom surface of the body for adhering the body to a horizontal surface of the back portion. A magnet or second adhesive is included to hold each of the legs to a vertical surface of said back portion.

These and other features and advantages of the invention will be apparent to those skilled in the art from the following detailed description, taken together with the accompanying drawings.

### BRIEF DESCRIPTION OF THE DRAWINGS

FIG. 1 is a side view of one embodiment of a laundry shelf according the present invention;

FIG. 2 is a top perspective view of the laundry shelf shown in FIG. 1;

FIG. 3 is another top perspective view of the laundry shelf shown in FIG. 1; and

FIG. 4 is a side view of another embodiment of a laundry shelf according the present invention;

### DETAILED DESCRIPTION OF THE INVENTION

The different embodiments of laundry shelves according to the present invention can be quickly and easily mounted directly to clothes washer or dryer machine (“laundry machines”). The shelves provide a surface that blocks and prevents clothes and other items from falling behind the laundry machines during use. The shelves also provide a sturdy shelf to hold items such as laundry detergent and softener containers. The shelf according to the present invention use a unique design that allows for mounting and attachment without the need for forming holes in the laundry machine or the adjacent wall. There is no need to screw, bolt, nail or rivet the shelf to the laundry machine or wall. Instead, the unique design allows for reliable mounting using only conventional adhesives and rubber pads. It is understood, however, that other embodiments can utilize other mounting materials and devices.

Some embodiments of the shelves according to the present invention can utilizes a cantilever design similar to designs utilized in bridges that have lasted hundreds of years. The shelf can mount directly to the laundry machine, with some embodiments being mounted on top of the top control panel of standard laundry machine. For those laundry machines not having a top control panel (such as front loading laundry machines), the shelf according to the invention can be mounted directly to the top surface of the laundry machine.

The present invention is described herein with reference to certain embodiments, but it is understood that the invention can be embodied in many different forms and should not be construed as limited to the embodiments set forth herein. Although the different embodiments of shelves discussed below are directed to use with laundry machines, it is understood that they can be used in many other applications, such as with other appliances or in other locations having an adjacent space.

It is also understood that when an element is referred to as being “on” another element, it can be directly on the other element or intervening elements may also be present. Furthermore, relative terms such as “upper”, “above”, “lower”, “beneath”, and “below”, “horizontal”, “vertical” and similar terms, may be used herein to describe a relationship of features. It is understood that these terms are intended to encompass different orientations of the device in addition to the orientation depicted in the figures.

Although the terms first, second, etc. may be used herein to describe various elements or components, these elements or components should not be limited by these terms. These terms are only used to distinguish one element or component from another. Thus, a first element or component discussed below could be termed a second element or component without departing from the teachings of the present invention.

Embodiments of the invention are described herein with reference to view illustrations that are schematic illustrations of embodiments of the invention. As such, the actual thickness of the layers can be different, and variations from the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing. A region illustrated or described as square or rectangular will typically have rounded or curved features due to normal manufacturing tolerances. Thus, the regions illustrated in the figures are schematic in nature and their shapes are not intended to illustrate the precise shape of a region of a device and are not intended to limit the scope of the invention.

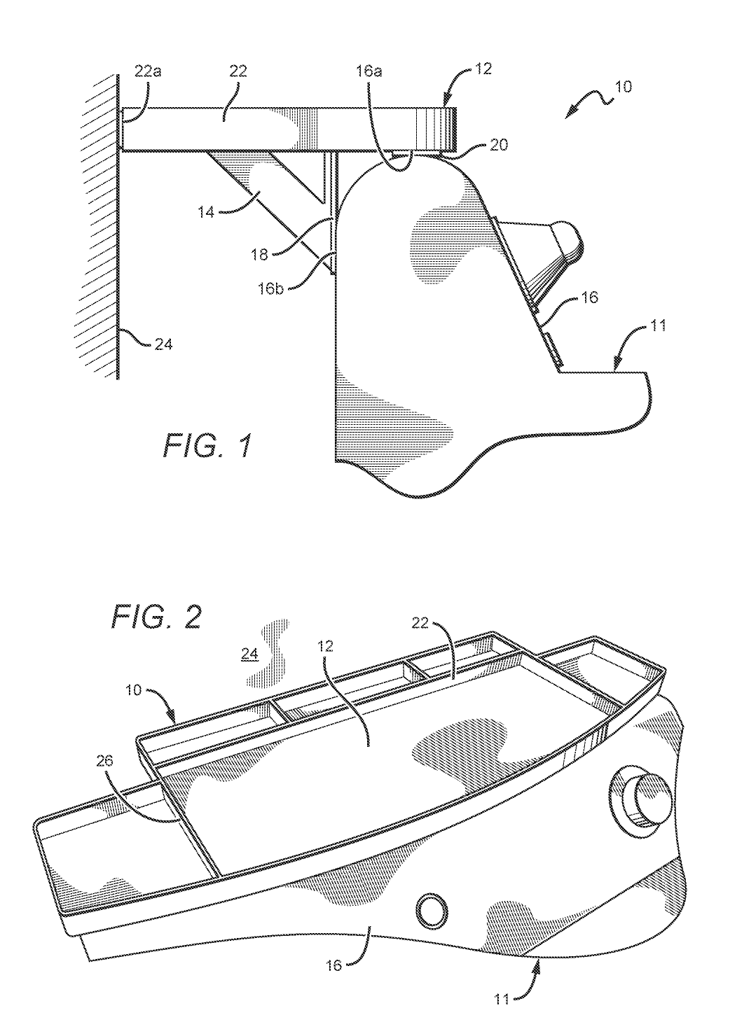

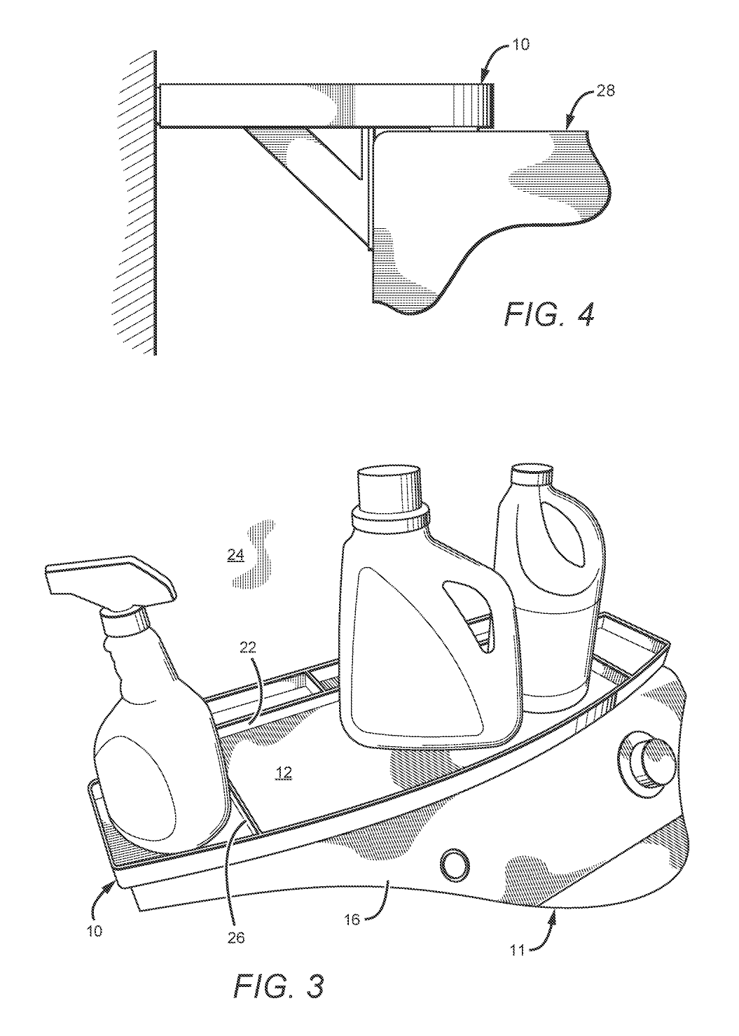

FIG. 1-3 show one embodiment of a laundry shelf 10 according to the present invention, that comprises a body 12 with one or more legs 14 that are best shown in FIG. 1. Different embodiments can have different numbers of legs, with the embodiments shown having two legs. In some embodiments, the legs 14 can be detachable from the body for ease of shipping and storage. The legs 14 are attached to the underside surface of the body 12 and in some embodiments the legs 14 can be formed integral to the body 12, such as through injection molding. In other embodiments the legs can be attached to the underside of the body such as by adhesive, screws, clamps, brackets, etc. Still in other embodiments the legs 14 can be attached to the body 12 by cooperating structures, such as a tab on the legs 14 that cooperates with a channel or opening in the body 12. These are only some of the attachment mechanisms that can be used in different embodiments according to the present invention.

The laundry shelf 10 mounts to a laundry machine 11 and in the embodiment shown, mounts on top of the laundry machine control panel 16. The legs are 14 arranged to make contact with the control panel's top surface 16a and upper back surface 16b. The surface of each of the legs 14 facing the upper back surface 16b can have an adhesive or magnetic strip 18 that holds the leg against the surface 16b and facilitates contact with the metal plate on the upper back of the washer or dryer.

The bottom surface of the body above the control panel's top surface 16a can have an adhesive 20. Many different adhesives can be used such as glues, cements and tape, with the embodiment shown using double sided tape. Once contact between the legs 14 and surface 16b is slid down until adhesive 20 makes contact with the top surface 16a. The adhesive 20 makes contact with a relatively small area of the surface 16a and a strong adhesive should be used to create a very tight bond between body 12 and the top surface 16a. The cantilever arrangement of the legs 14 creates a sheer affect at the top of the control panel between the shelf 10 and the top surface 16a that magnifies the power of the adhesive, and in some embodiments the power of the adhesive can be magnified several fold.

The body 12 can have a perimeter wall 22 around its edge that not only forms a containment edge for the top of the body 12, but can also provide a surface that assists in the mounting strength and reliability of the shelf 10. Once the shelf 10 is in place on the control panel 16, the washer or dryer can be moved toward the wall 24 adjacent the back of the laundry machine. The perimeter wall 22 forms a back edge 22a of the body 12 and as the laundry machines moves toward the wall the back edge 22a can contact the wall 24. The shelf utilizes the stability inherent in the wall 24 combined with the adhesive 20 and the cantilever leg 24 to create a stable platform that will provide several benefits. In some embodiments, the back edge 22a can have an adhesive or other material, such a rubber pad, to enhance the contact between the back edge 22a and the wall 24.

When mounted in place, the shelf 10 fills the gap behind the laundry machine to stop items from falling behind the machine. The shelf 10 provide a stable platform for the storage of laundry cleaning items. The shelf 10 can have internal vertical walls 26 that form compartments on the top surface of the body 12 that can be used to hold smaller items, such as those that are found in the washer/dryer.

The laundry shelves according to the present invention can be used with different types of laundry machines having control panels with different shapes and sizes. It can also be used with laundry machines that do not have a control panel like the one shown in FIGS. 1-3. For example, many front loading laundry machines do not have a control panel. FIG. 4 shows the laundry shelf 10 mounted to a laundry machine 28 not having a control panel, and instead of mounting on the control panel the shelf 10 mounts to the back edge of the laundry machine using the exact same technique, methods and materials as described above and shown in FIGS. 1-3.

Embodiments of the laundry shelf according to the present invention can also comprise components that allow for mounting to different sized laundry machines. Some embodiments can comprise an additional spacer for those laundry machines that sit farther away from the back wall than others. If the back edge of the shelf does not make contact with the back wall then the spacer can be mounted to the back edge of the shelf body to fill the space and to complete the installation.

The shelves according to the present invention can be made of many rigid materials such as plastics, metal, wood, or combinations thereof. The different embodiments can be formed as a single unit such as through molding processes, or different components can be formed separately and the shelf assembled for use.

Although the present invention has been described in detail with reference to certain preferred configurations thereof, other versions are possible. Therefore, the spirit and scope of the invention should not be limited to the versions described above. The foregoing is intended to cover all modifications and alternative methods falling within the spirit and scope of the invention. No portion of the disclosure is intended, expressly or implicitly, to be dedicated to the public domain if not set forth in any claims.

I claim:

1. A laundry shelf, comprising:
a planar body having a bottom surface, a top surface and a perimeter wall;
one or more legs on the bottom surface of the body;
a first adhesive on the front bottom surface of the body for adhering said body to a first surface of a laundry machine; and
a magnet or second adhesive to hold each of said legs to a second surface of a laundry machine.

2. The laundry shelf of claim 1, wherein said legs are arranged in a cantilever fashion.

3. The laundry shelf of claim 1, further comprising a rubber pad mounted to the outside surface of said perimeter wall.

4. The laundry shelf of claim 1, further comprising a spacer mounted to said perimeter wall.

5. The laundry shelf of claim 1, wherein said first adhesive comprises double-sided tape.

6. A laundry shelving system, comprising:
a laundry machine having front and back portions;
a wall adjacent said laundry machine back portion, with a space there between;
a laundry machine shelf mounted to said back portion and spanning the space between said laundry machine and said wall, said shelf comprising:
a planar body having a bottom surface, a top surface and a perimeter wall;
one or more legs on the bottom surface of the body;
a first adhesive on the front bottom surface of the body for adhering said body to horizontal surface of said back portion; and
a magnet or second adhesive to hold each of said legs to a vertical surface of said back portion.

7. The system of claim 6, wherein said legs are arranged in a cantilever fashion.

8. The system of claim 6, further comprising a rubber pad mounted to the outside surface of said perimeter wall.

9. The system of claim 6, further comprising a spacer mounted to said perimeter wall.

10. The system of claim 6, wherein said first adhesive comprises double-sided tape.
